(19) United States
(12) Patent Application Publication
(10) Pub. No.: US 2021/0221465 A1
(43) Pub. Date: Jul. 22, 2021

(54) MOTORCYCLE WITH MULTI-CONFIGURATION CHASSIS

(71) Applicant: Giacomo BERTI, Carrara (IT)

(72) Inventor: Giacomo BERTI, Carrara (IT)

(21) Appl. No.: 16/066,918

(22) PCT Filed: Dec. 27, 2016
(86) PCT No.: PCT/IT2016/000309

§ 371 Date: Jun. 28, 2018

(30) Foreign Application Priority Data
Dec. 31, 2015 (IT) 102015000089514

(51) Int. Cl. B62K 25/08; B62K 25/04

(52) U.S. Cl. CPC B62K 25/08; B62K 2201/04; B62K 2025/044; B62K 2025/045; B60G 2300/12

(57) ABSTRACT

A motorcycle with multi-configuration chassis including: a rigid chassis assembly (Z6) for supporting the engine and the auxiliary fuel feed and mechanical devices; a rear fork assembly; a front fork assembly; —a saddle assembly, where the multi-configuration chassis includes at least one hydraulic or electric cylinder adapted to modify its length to allow at least one adjustment selected from the following: rear fork assembly lengthening, front fork assembly tilt, front fork assembly lengthening, saddle assembly tilt. A multi-body kinematic mechanism for a rear fork assembly of a motorcycle, adapted to be fitted to a rigid chassis assembly of a motorcycle to allow the configuration thereof to be varied by element of variation of the length of a hydraulic or electric cylinder.

The invention relates to the motorcycling sector.

More in detail, the invention relates to a motorcycle with multi-configuration chassis comprising kinematic mechanism assemblies by means of which the configuration of the motorcycle can be changed.

In the description below, although reference will mainly be made to a motorcycle, the multi-configuration chassis described and claimed can also refer, “mutatis mutandis”, to other motor- or pedal-driven vehicles, such as bicycles, tricycles, etc.

The invention also relates to a multi-body kinematic mechanism for a rear fork assembly of a motorcycle having a rigid chassis, adapted to allow the configuration of the motorcycle to be varied.

There are known motorcycles comprising:
a rigid chassis assembly for supporting the engine and the auxiliary fuel feed and mechanical devices;
a rear fork assembly;
a front fork assembly;
a saddle assembly,

where said rear fork, front fork and saddle assemblies are fitted to said rigid chassis assembly without the possibility of changing the configuration thereof easily and rapidly and without modifying the response of the suspensions associated with the rear and front fork assembly.

In particular, the most widely used rear fork assemblies of known type are:
direct, in which the suspension is coupled directly to the swing arm, as in double cross systems;
with linkages, in which the suspension is connected by means of a system of levers and arms, which allow a response of the non-linear suspension to be obtained. Generally, the linkage system is used to obtain low spring compression in the initial portion of wheel travel, so as to have greater riding comfort on uneven ground, and compression of the spring is then increased gradually as the travel of the wheel increases.
a cantilever system, consisting of a swing arm with a supplementary triangular structure that acts on a shock absorber arranged horizontally, which can operate in compression or in extension.

However, none of these systems is without defects, nor do they allow rapid transition from one configuration to another without modifying the response of the shock absorber.

The object of the invention is to define a motorcycle with multi-configuration chassis that allows the configuration of the motorcycle to be easily and rapidly changed, without having to modify the transmission or the suspensions of the vehicle.

The object of the invention is achieved with a motorcycle with multi-configuration chassis according to the independent claim 1 and with a multi-body kinematic mechanism for a rear fork assembly of a motorcycle according to the independent claim 6.

Further features of the invention are described in the respective subsequent dependent claims.

The main advantage of the present invention lies in the fact that by combining the various adjustments allowed by variation of the length of a hydraulic or electric cylinder belonging to the different kinematic mechanisms associated with the front fork, rear fork and saddle assembly, a large number of configurations of the motorcycle are obtained.

The extension or retraction of a hydraulic or electric cylinder belonging to said kinematic mechanisms allows an increase or a decrease of the pitch of the motorcycle and/or a decrease or lowering of the height of the saddle from the ground to be obtained.

Further features and advantages of the invention will be more evident from the more detailed description set forth below, with the aid of the drawings, which show a preferred implementation thereof, illustrated by way of non-limiting example, wherein:

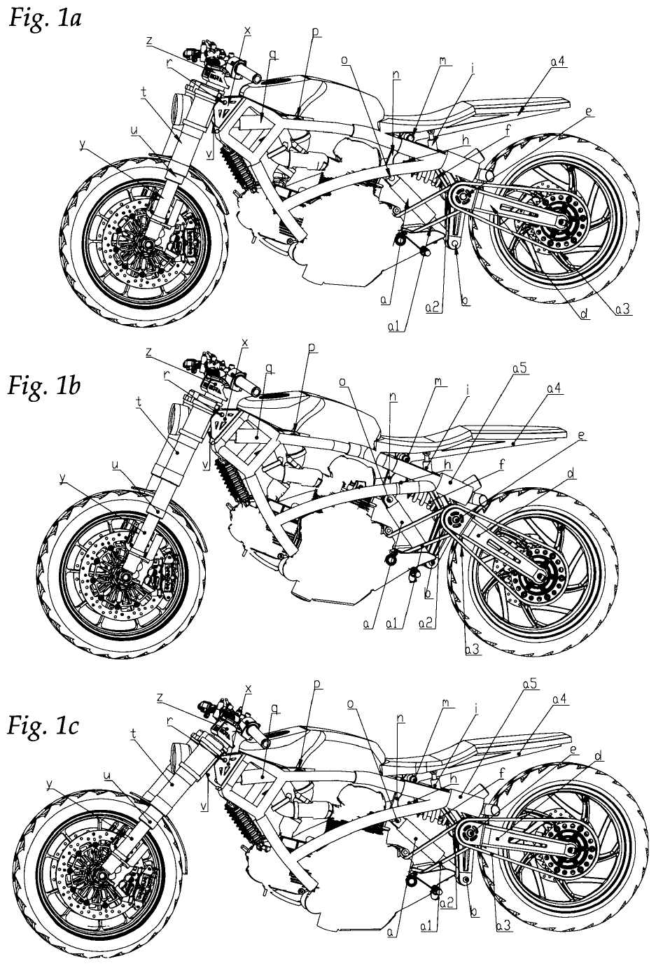

FIGS. 1a, 1b, 1c show, in an axonometric view, a motorcycle with multi-configuration chassis according to the invention, illustrated in three different configurations of the countless configurations in which the motorcycle can be configured;

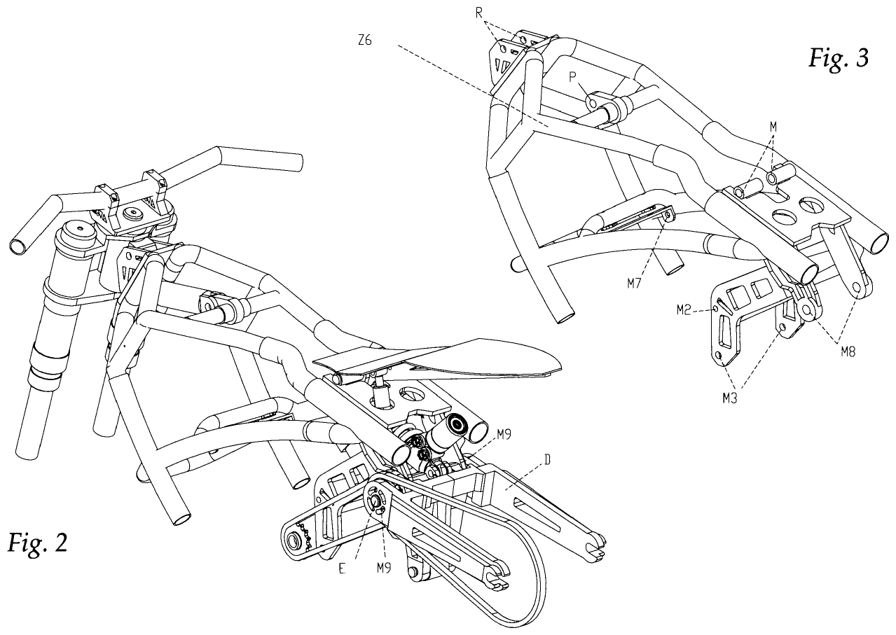

FIG. 2 shows, in a partially sectioned axonometric view, the multi-configuration chassis complete with rigid chassis assembly, front fork assembly, rear fork assembly and saddle assembly;

FIG. 3 shows, in a partially sectioned axonometric view, only the rigid chassis;

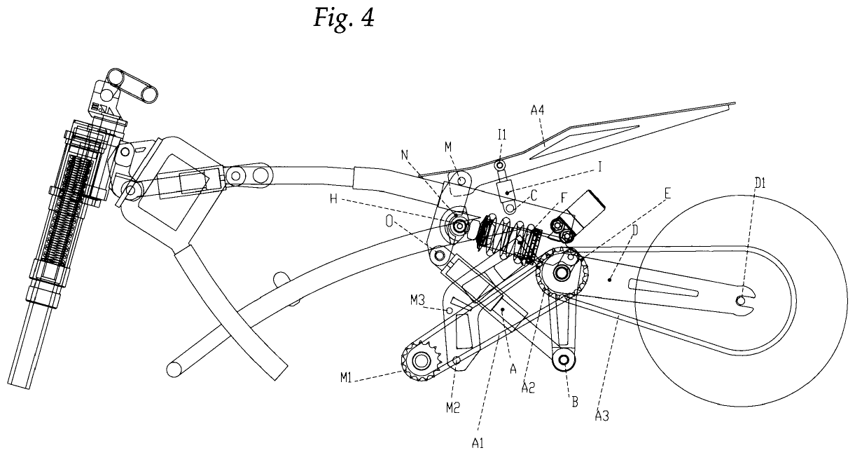

FIG. 4 shows, in a partially sectioned transparent side view, the multi-configuration chassis complete with transmission assembly and rear wheel;

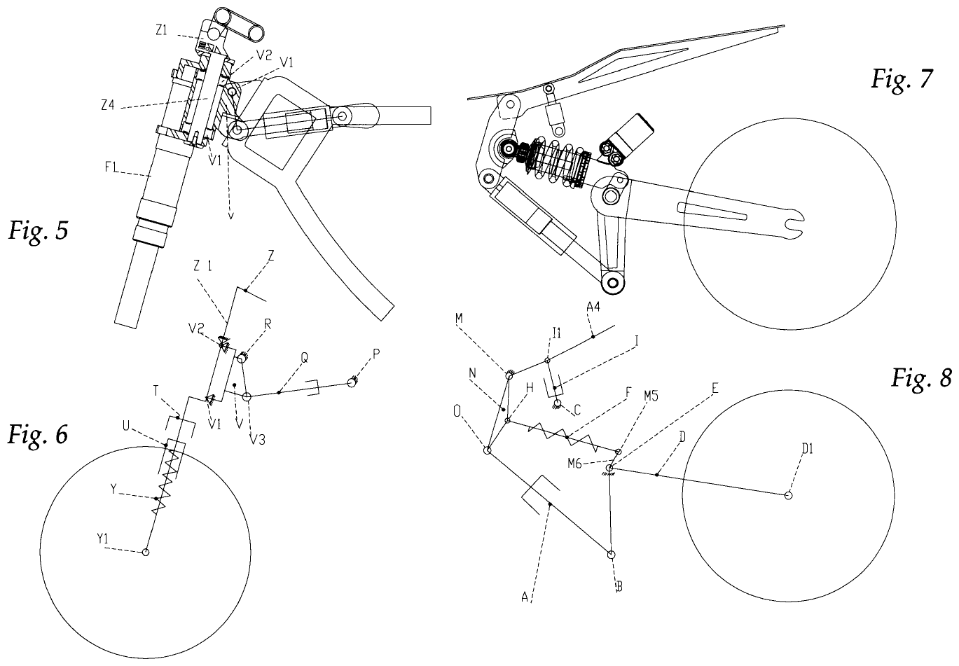

FIG. 5 shows, in partially sectioned transparent side view, the system for adjusting the front fork assembly;

FIG. 6 shows a diagram of the kinematic mechanism structure of the system for adjusting the front fork assembly;

FIG. 7 shows, in a partially sectioned transparent side view, the system for adjusting the rear fork assembly and the saddle assembly;

FIG. 8 shows a diagram of the kinematic structure of the system for adjusting the rear fork assembly and the saddle assembly;

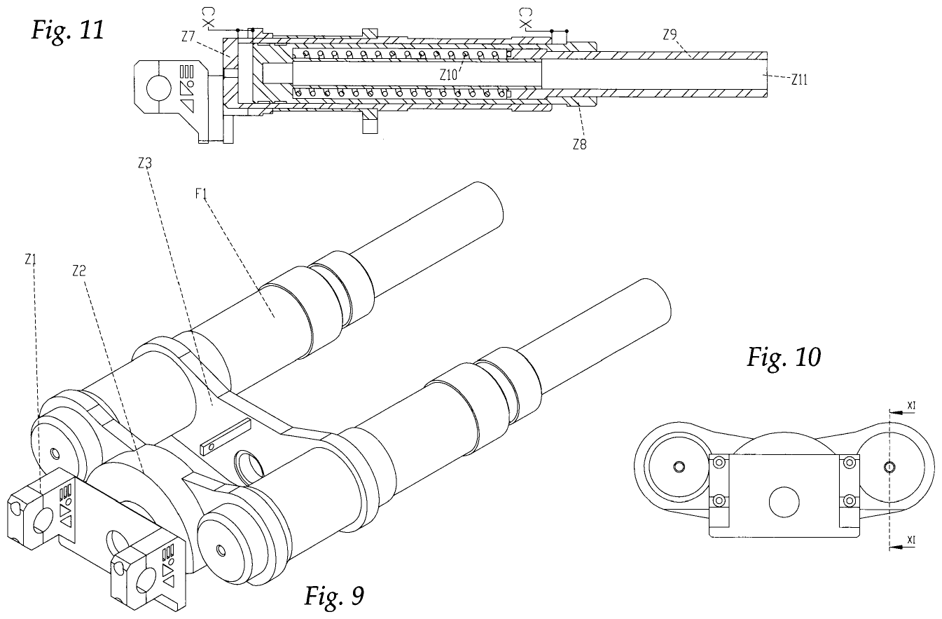

FIGS. 9, 10 and 11 represent, respectively in a partially sectioned perspective view, in a top plan view and in a section along the line XI-XI of FIG. 10, the system for adjusting the length of the front forks.

With reference to the details of the figures, a motorcycle with multi-configuration chassis comprises:
a rigid chassis assembly Z6 for supporting the engine and the auxiliary fuel feed and mechanical devices;
a rear fork assembly D;
a front fork assembly Z1;
a saddle assembly A4.

With reference to FIGS. 2, 3 and 4, the engine of the motorcycle is connected to the rigid chassis Z6 in the points M2, M3 and M7. The output pinion M1 of the engine transmits motion to the double pinion A2 by means of the chain A1. The double pinion rotates mounted on a shaft in the point E, the shaft is housed on bushings fixed in the points M8 in the rigid chassis and in the points M9 in the rear fork D. The seats M8 and M9 are concentric to the point E. By means of the chain A3 the double pinion transmits motion to the wheel rotatable with axle in the point Dl.

FIGS. 5, 6, 7 and 8 schematically show the front fork, rear fork and saddle assemblies, and the structural diagrams of their kinematic mechanisms for adjustment.

With reference to FIGS. 5 and 6, the tilt of the fork F1 of the front wheel is implemented by means of varying the length of the rod Q connected to the chassis by means of the hinge P.

The rod Q can either be a hydraulic or electric cylinder or any other linear actuating means that allows the rod Q to extend or retract. The rod with variable length Q is connected to the rigid body V for supporting the forks by means of the connection V3.

Rotation of the body V around the fulcrum R, connected to the rigid chassis, allows rotation of the forks. The body V, by means of the bearings V1 and V2, acts both as axial and radial support for the front fork assembly F1 and handlebar mounting Z1, better represented in FIGS. 9, 10 and 11.

The body V, in jargon “steering head”, is anchored to the forks and to the handlebar mounting through the plates Z2 and Z3 represented in FIG. 9.

With reference to FIGS. 5, 9 and 10, there is depicted the pin Z4 that connects the body V to the fork F1-fork plate Z2, Z3 and handlebar mounting Z1 assembly.

With reference to FIG. 11, the front forks are adjustable in length. The cylinder Z7 incorporates a shock absorber formed by the cylinder Z8, by the stem Z9 and by the spring Z10.

By feeding oil into the cylinder Z7, in the case in which the system is hydraulic, the cylinder Z8 moves and the whole of the hydraulic shock absorbing system moves as a consequence.

The actuator that moves the shock absorber can be a hydraulic cylinder, such as the component Z9, or can be electric, or implemented with any other linear system of known type.

The rear fork assembly D illustrated in FIG. 8 is connected to the rigid chassis assembly by means of the points M and E.

The rear fork indicated with the letter D is hinged to the rigid chassis assembly in the fulcrum E. The fork, schematized as rigid body, rotates around the point E by means of the rod with variable length indicated with the letter A. The fork D is hinged to the rod A by means of the hinge B. The rod A, variable in length, is a hydraulic cylinder (variable rod) that can also be an electric cylinder or an automatic linear guide, according to the manufacturer's needs.

The extension or retraction of the rod A allows rotation of the fork D, which determines an increase or decrease of the pitch of the motorcycle and/or a decrease or lowering of the height of the saddle from the ground, this latter also being adjustable by varying the configuration of the front forks.

The rod A, which for simplicity is identified with the name of the cylinder, is connected to the rigid body N by means of the hinge O.

The rigid body N is hinged to the rigid chassis assembly by means of the point M. The rigid body N, by means of the hinge H, is connected to the rod with variable length indicated with the letter F.

The rod with variable length F is the rear shock absorber of the motorcycle. The shock absorber is connected to the rigid body which is the fork D, by means of the hinge M5.

The shock absorber F exerts a resistant moment around the fulcrum E through to the arm M6 of the fork D. Once the travel of the cylinder A has been blocked, the kinematic mechanism allows the wheel to move so as to compress the shock absorber F.

The kinematic mechanism also works if the positions of the cylinder A and the shock absorber F are inverted, so that the cylinder A takes the position of the shock absorber F and vice versa.

The substantial difference lies in the operation of the shock absorber, which in the configuration indicated in FIGS. 7 and 8, is a shock absorber that works in compression, i.e., it is compressed, while with the second construction method, which can in any case be implemented with the same kinematic mechanism, it works in traction, i.e., it is extended.

Adjustment of the tilt of the saddle assembly A4 is reproduced in FIGS. 5 and 6.

The saddle A4 rotates around the fulcrum M, connected to the rigid chassis Z6, as illustrated in FIGS. 4, 7 and 8, through the rod with variable length l, which can be a cylinder or a variable linear element.

The rod I is hinged in the point C connected to the rigid chassis and in the point I1 connected to the saddle A4.

1. A motorcycle with multi-configuration chassis comprising:
a rigid chassis assembly (Z6) for supporting the engine and the auxiliary fuel feed and mechanical devices;
a rear fork assembly;
a front fork assembly; and
a saddle assembly,
wherein said multi-configuration chassis comprises at least one hydraulic or electric cylinder adapted to modify its length to allow at least one adjustment selected from the following: rear fork assembly lengthening, front fork assembly tilt, front fork assembly lengthening, saddle assembly tilt.

2. The motorcycle with multi-configuration chassis according to claim 1, wherein said rear fork assembly comprises:
a rigid fork (D) hinged to the rigid chassis assembly (Z6) in a fulcrum (E);
a rod with variable length comprising a hydraulic or electric cylinder having a first end connected to the fork (D) by means of a hinge (B) and a second end connected to a rigid body (N) by means of a hinge connection (O);
a rigid body (N) rotatingly connected to the rigid chassis assembly (Z6) by means of a hinge (M); and
a rod with variable length (F) forming the rear shock absorber of the motorcycle having a first end connected to the rigid fork (D) by means of a hinge (M5) and an arm (M6) and a second end connected to the rigid body (N) by means of a hinge connection (H).

3. The motorcycle with multi-configuration chassis according to claim 1, wherein said front fork assembly comprises a rigid support body (V), connected to said rigid chassis assembly (Z6) by means of a pivot (R), and a hydraulic or electric cylinder (Q) comprising a first end connected to the rigid chassis assembly (Z6) by means of a hinge (P) and a second end connected to said rigid support body (V) of the front fork assembly by means of a hinge connection (V3).

4. The motorcycle cycle with multi-configuration chassis according to claim 1, wherein said front fork assembly comprises a hydraulic or electric cylinder (Z7) incorporating in a sliding manner a shock absorber consisting of a cylinder (Z8), of a stem (Z9) and of a spring (Z10).

5. The motorcycle with multi-configuration chassis according to claim 1, wherein said saddle assembly comprises:
a saddle (A4) connected to the rigid chassis by means of a hinge with fulcrum (M); and
a rod with variable length (I) comprising a hydraulic or electric cylinder having a first end connected to the rigid chassis assembly (Z6) by means of a hinge (C) and a second end connected to the saddle (A4) by means of a hinge connection (I1).

6. A multi-body kinematic mechanism for a rear fork assembly of a motorcycle, wherein said kinematic mechanism comprises four elements connected to one another:
a first and a second rigid body;
a hydraulic or electric cylinder; and
a shock absorber,
wherein said kinematic mechanism is adapted to be fitted to a rigid chassis assembly (Z6) of a motorcycle to allow the configuration thereof to be varied by means of variation of the length of said hydraulic or electric cylinder.

7. The multi-body kinematic mechanism for motorcycle according to claim 6, wherein:
said first rigid body comprises a rigid fork (D) hinged to the rigid chassis assembly in a fulcrum (E);
said second rigid body comprises a rigid body (N) rotatingly connected to the rigid chassis assembly by means of a hinge (M);
said hydraulic or electric cylinder comprises a first end connected to the fork (D) by means of a hinge (B) and a second end connected to a rigid body (N) by means of a hinge connection (O); and
said shock absorber comprises a rod with variable length (F) forming the rear shock absorber of the motorcycle, having a first end connected to the rigid fork (D) by means of a hinge (M5) and an arm (M6) and a second end connected to the rigid body (N) by means of a hinge connection (H).
